(19) United States
(12) Patent Application Publication
(10) Pub. No.: US 2020/0406343 A1
(43) Pub. Date: Dec. 31, 2020

(54) SPRUE SPREADER SURFACE TREATMENT METHOD

(71) Applicant: CITIC Dicastal Co., Ltd., Qinhuangdao (CN)

(72) Inventors: Xin LIU, Qinhuangdao (CN); Zhigao YIN, Qinhuangdao (CN); Chunhai LIU, Qinhuangdao (CN); Shide LI, Qinhuangdao (CN)

(21) Appl. No.: 16/705,151

(22) Filed: Dec. 5, 2019

(30) Foreign Application Priority Data
Jun. 27, 2019 (CN) 2019105655939

(51) Int. Cl. B22D 35/04; B22D 45/00; B08B 7/00

(52) U.S. Cl. CPC B22D 35/04; B08B 7/0021; B22D 45/00

(57) ABSTRACT

The disclosure discloses a sprue spreader surface treatment method, which comprises the following steps: preheating the sprue spreader, and carrying out laser scanning on the sprue spreader by using a laser; cleaning the surface of the sprue spreader, drying it by hot air, and polishing the surface to be bright by pneumatic polishing; and cleaning the surface of the sprue spreader again and drying it by hot air, so that the operation is simple, the cost is low, the bonding strength is high, the energy is saved, the environment is protected, and the service life of the sprue spreader can be prolonged.

### FIELD

The disclosure relates to the technical field of metal surface treatment, in particular to a sprue spreader surface treatment method.

### BACKGROUND

The aluminum alloy hub is a hollow drum-shaped part, the central hole of which is an ideal casting opening, and the core for forming the central hole of which is also a sprue spreader. The sprue spreader is fixed at the center of the die cavity of the mold, when the aluminum liquid enters the mold, the aluminum liquid firstly flows through the sprue spreader at the tail end of the main flow passageway and then fills the die cavity, and each time a wheel hub is cast, the surface layer of the sprue spreader is contacted with the high-temperature molten aluminum once, so that the surface layer of the sprue spreader is softened because of the increasing temperature, and the erosion resistance is reduced. Each time after opening the mold, it is needed to blow and spray compressed air and lubricating coating on the surface of the sprue spreader to make it be rapidly cooled, so that the surface layer of the sprue spreader is subjected to periodic thermal stress and corrosion action, and the formation and expansion of surface microcracks are caused, and finally, the thermal fatigue phenomena of cracking and stripping occur. At high temperatures, aluminum is an element that is easy to corrode iron. The generation and the expansion of the cracks of the substrate can accelerate the corrosion and the erosion of the aluminum liquid to the substrate of the sprue spreader. For the above reasons, the sprue spreader will be scrapped due to hot melting loss. Therefore, how to improve the thermal fatigue resistance, the wear resistance, the corrosion resistance and other treatment technologies of the sprue spreader is an important problem to be solved by engineering technicians. The common points of quenching, tempering, carburizing, nitriding, electroplating, nitrocarburizing, ion implantation and the like are short service life and complex process.

### SUMMARY

In view of the above, the present disclosure aims to provide a method for casting the surface of the sprue spreader of the aluminum alloy hub mold, which is simple to operate, low in cost, high in bonding strength, energy-saving, and environment-friendly, and can prolong the service life of the sprue spreader.

In order to achieve the above object, the technical scheme of the disclosure is realized as follows:

A sprue spreader surface treatment method comprises the following steps:

S1, cleaning the surface of the sprue spreader, and drying it by hot air;

S2, setting supersonic plasma spraying process parameters, wherein the voltage is 100-150 V, the current is 380-450 A, the spraying distance is 85-115 mm, the gas injection flow is 4.0-4.5 m3/h, the flight speed is 380-480 m/s, and the temperature is 1900-2500° C.;

S3, controlling a spray gun to spray tungsten carbide powder on the surface of the sprue spreader by using a programmable control robot;

S4, cleaning the surface of the sprue spreader, and drying it by hot air;

S5, setting laser fusion process parameters: the positive defocus of the focal position of the light spot of the laser is 5-7 mm, the scanning speed is 2-3.5 mm/s, the scanning power is 3-4 KW, the overlap joint rate is 10-15%, the protective gas is N2, the oxygen content is below 200 ppm, and coaxially blowing air, and after the sprue spreader is preheated, carrying out laser scanning the sprue spreader by using a laser; and

S6, cleaning the surface of the sprue spreader, drying it by hot air, and polishing the surface to be bright by pneumatic polishing; then cleaning the surface of the sprue spreader, and drying it by hot air.

In one embodiment, the thickness of the tungsten carbide after coating is 10-15 μm.

In one embodiment, the hot air drying temperature is 60° C.

In one embodiment, the grain diameter of the carbide powder sprayed on the surface of the sprue spreader by the programmable control robot controlling the spray gun is 15-20 μm.

In one embodiment, the light spot of the laser comprises a circular light spot with a diameter of 3 mm.

In one embodiment, the positive defocus of the focal position of the light spot of the laser is 6 mm, and the scanning speed is 2.5-3 mm/s.

In one embodiment, in step S4, the preheating temperature of the sprue spreader is 80° C., and the preheating time is 25 min.

In one embodiment, the laser comprises a CO2 laser.

Compared with the prior art, the sprue spreader surface treatment method has the following advantages that:

The sprue spreader surface treatment method according to the present disclosure, the tungsten carbide powder is sprayed on the sprue spreader through supersonic spraying, and then the tungsten carbide powder is remelted through the laser to form metallurgical bonding with the substrate, so that the operation is simple, the cost is low, the bonding strength is high, the energy is saved, the environment is protected, and the service life of the sprue spreader can be prolonged.

### BRIEF DESCRIPTION OF THE DRAWINGS

The accompanying drawings forming a part of the present disclosure are used to provide a further understanding of the present disclosure, and the schematic embodiments and the descriptions of the present disclosure serve to explain the present disclosure and do not constitute an improper limitation of the present disclosure. In the drawings:

FIG. 1 is a flow chart of the sprue spreader surface treatment method according to the present disclosure;

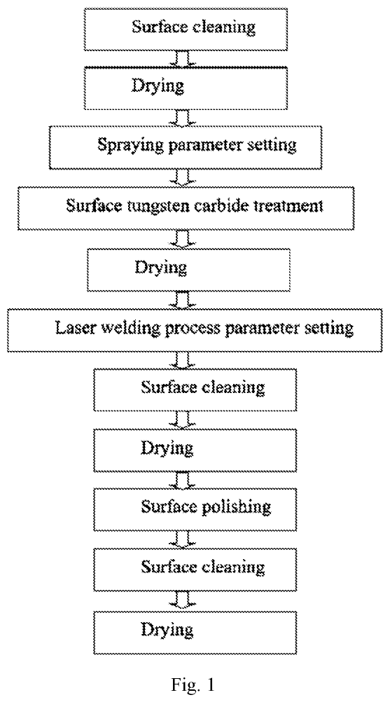

### DETAILED DESCRIPTION OF THE EMBODIMENTS

It should be noted that the embodiments and the features in the embodiments of the present disclosure may be combined with each other without conflict.

The technical solution of the present disclosure will be described more clearly and completely with reference to the accompanying drawings in conjunction with the embodiments, and it is apparent that the described embodiments are only some but not all embodiments of the present disclosure. All other embodiments which can be obtained by a person with ordinary skill in the art without making any creative work based on the embodiments of the present disclosure belong to the claimed scope of the present disclosure.

### Embodiment 1

Firstly, cleaning the surface of the sprue spreader by using alkali liquor to remove impurities such as oil stains and the like, and drying the sprue spreader by using hot air at 60° C.; by adopting a supersonic plasma spraying process, controlling a spray gun to spray tungsten carbide powder of 15 μm on the surface of the sprue spreader by using a programmable control robot UR10, wherein the voltage is 100V, the current is 380 A, the spraying distance is 85 mm, the gas injection flow is 4.0 m³/h, the flight speed is 380 m/s, and the temperature is 1900° C.; secondly, cleaning the surface of the sprue spreader by using alkali liquor, preheating the sprue spreader for 25 minutes at 80° C. after drying the sprue spreader by using hot air at 60° C., and carrying out laser scanning the sprue spreader by using a CO2 laser, wherein the light spot of the laser is a circular light spot with a diameter of 3 mm, the positive defocus of the focal position is 6 mm, the scanning speed is 3 mm/s, the scanning power is 4 KW, the overlap joint rate is 15%, the protective gas is N2, the oxygen content is below 200 ppm, and coaxially blowing air; cleaning the surface of the sprue spreader again, drying the sprue spreader by hot air at 60° C., and polishing the surface of the sprue spreader by pneumatic polishing; finally, cleaning the surface of the sprue spreader, and drying the sprue spreader by hot air at 60° C., to obtain the sprue spreader with the size and the surface finish meeting the requirements, and the thickness of the coated tungsten powder is 15 μm.

After spraying, the coating on the surface of the sprue spreader has a compactness of 95%, a bonding strength of 68 MPa, a porosity of 3.2%, and a coating density of 7.14 g/cm3.

### Embodiment 2

Firstly, cleaning the surface of the sprue spreader by using alkali liquor to remove impurities such as oil stains and the like, and drying the sprue spreader by using hot air at 60° C.; by adopting a supersonic plasma spraying process, controlling a spray gun to spray tungsten carbide powder of 17 μm on the surface of the sprue spreader by using a programmable control robot UR10, wherein the voltage is 120V, the current is 400 A, the spraying distance is 90 mm, the gas injection flow is 4.1 m³/h, the flight speed is 390 m/s, and the temperature is 2000° C.; secondly, cleaning the surface of the sprue spreader by using alkali liquor, preheating the sprue spreader for 25 minutes at 80° C. after drying the sprue spreader by using hot air at 60° C., and carrying out laser scanning the sprue spreader by using a CO2 laser, wherein the light spot of the laser is a circular light spot with a diameter of 3 mm, the positive defocus of the focal position is 6 mm, the scanning speed is 2.5 mm/s, the scanning power is 3 KW, the overlap joint rate is 10%, the protective gas is N2, the oxygen content is below 200 ppm, and coaxially blowing air; cleaning the surface of the sprue spreader again, drying the sprue spreader by hot air at 60° C., and polishing the surface of the sprue spreader by pneumatic polishing; finally, cleaning the surface of the sprue spreader, and drying the sprue spreader by hot air at 60° C., to obtain the sprue spreader with the size and the surface finish meeting the requirements, and the thickness of the coated tungsten powder is 10 μm.

After spraying, the coating on the surface of the sprue spreader has a compactness of 94%, a bonding strength of 72 MPa, a porosity of 2.8%, and a coating density of 7.24 g/cm3.

### Embodiment 3

Firstly, cleaning the surface of the sprue spreader by using alkali liquor to remove impurities such as oil stains and the like, and drying the sprue spreader by using hot air at 60° C.; by adopting a supersonic plasma spraying process, controlling a spray gun to spray tungsten carbide powder of 19 μm on the surface of the sprue spreader by using a programmable control robot UR10, wherein the voltage is 140V, the current is 420 A, the spraying distance is 100 mm, the gas injection flow is 4.2 m³/h, the flight speed is 410 m/s, and the temperature is 2100° C.; secondly, cleaning the surface of the sprue spreader by using alkali liquor, preheating the sprue spreader for 25 minutes at 80° C. after drying the sprue spreader by using hot air at 60° C., and carrying out laser scanning the sprue spreader by using a CO2 laser, wherein the light spot of the laser is a circular light spot with a diameter of 3 mm, the positive defocus of the focal position is 6 mm, the scanning speed is 3 mm/s, the scanning power is 3.5 KW, the overlap joint rate is 11%, the protective gas is N2, the oxygen content is below 200 ppm, and coaxially blowing air; cleaning the surface of the sprue spreader again, drying the sprue spreader by hot air at 60° C., and polishing the surface of the sprue spreader by pneumatic polishing; finally, cleaning the surface of the sprue spreader, and drying the sprue spreader by hot air at 60° C., to obtain the sprue spreader with the size and the surface finish meeting the requirements, and the thickness of the coated tungsten powder is 12 μm.

After spraying, the coating on the surface of the sprue spreader has a compactness of 97%, a bonding strength of 68 MPa, a porosity of 3.0%, and a coating density of 7.97 g/cm3.

### Embodiment 4

Firstly, cleaning the surface of the sprue spreader by using alkali liquor to remove impurities such as oil stains and the like, and drying the sprue spreader by using hot air at 60° C.; by adopting a supersonic plasma spraying process, controlling a spray gun to spray tungsten carbide powder of 20 μm on the surface of the sprue spreader by using a programmable control robot UR10, wherein the voltage is 150V, the current is 450 A, the spraying distance is 115 mm, the gas injection flow is 4.5 m³/h, the flight speed is 480 m/s, and the temperature is 2500° C.; secondly, cleaning the surface of the sprue spreader by using alkali liquor, preheating the sprue spreader for 25 minutes at 80° C. after drying the sprue spreader by using hot air at 60° C., and carrying out laser scanning the sprue spreader by using a CO2 laser, wherein the light spot of the laser is a circular light spot with a diameter of 3 mm, the positive defocus of the focal position is 6 mm, the scanning speed is 2.5 mm/s, the scanning power is 3 KW, the overlap joint rate is 12%, the protective gas is N2, the oxygen content is below 200 ppm, and coaxially blowing air; cleaning the surface of the sprue spreader again, drying the sprue spreader by hot air at 60° C., and polishing the surface of the sprue spreader by pneumatic polishing; finally, cleaning the surface of the sprue spreader, and drying the sprue spreader by hot air at 60° C., to obtain the sprue spreader with the size and the surface finish meeting the requirements, and the thickness of the coated tungsten powder is 11 μm.

After spraying, the coating on the surface of the sprue spreader has a compactness of 92%, a bonding strength of 68 MPa, a porosity of 3.0%, and a coating density of 7.33 g/cm3.

### Embodiment 5

Firstly, cleaning the surface of the sprue spreader by using alkali liquor to remove impurities such as oil stains and the like, and drying the sprue spreader by using hot air at 60° C.; by adopting a supersonic plasma spraying process, controlling a spray gun to spray tungsten carbide powder of 18 μm on the surface of the sprue spreader by using a programmable control robot UR10, wherein the voltage is 130V, the current is 430 A, the spraying distance is 110 mm, the gas injection flow is 4.4 m³/h, the flight speed is 430 m/s, and the temperature is 2300° C.; secondly, cleaning the surface of the sprue spreader by using alkali liquor, preheating the sprue spreader for 25 minutes at 80° C. after drying the sprue spreader by using hot air at 60° C., and carrying out laser scanning the sprue spreader by using a CO2 laser, wherein the light spot of the laser is a circular light spot with a diameter of 3 mm, the positive defocus of the focal position is 6 mm, the scanning speed is 3 mm/s, the scanning power is 4 KW, the overlap joint rate is 14%, the protective gas is N2, the oxygen content is below 200 ppm, and coaxially blowing air; cleaning the surface of the sprue spreader again, drying the sprue spreader by hot air at 60° C., and polishing the surface of the sprue spreader by pneumatic polishing; finally, cleaning the surface of the sprue spreader, and drying the sprue spreader by hot air at 60° C., to obtain the sprue spreader with the size and the surface finish meeting the requirements, and the thickness of the coated tungsten powder is 13 μm.

After spraying, the coating on the surface of the sprue spreader has a compactness of 89%, a bonding strength of 71 MPa, a porosity of 2.88%, and a coating density of 7.16 g/cm3.

### Embodiment 6

Firstly, cleaning the surface of the sprue spreader by using alkali liquor to remove impurities such as oil stains and the like, and drying the sprue spreader by using hot air at 60° C.; by adopting a supersonic plasma spraying process, controlling a spray gun to spray tungsten carbide powder of 16 μm on the surface of the sprue spreader by using a programmable control robot UR10, wherein the voltage is 110V, the current is 390 A, the spraying distance is 95 mm, the gas injection flow is 4.3 m³/h, the flight speed is 450 m/s, and the temperature is 2200° C.; secondly, cleaning the surface of the sprue spreader by using alkali liquor, preheating the sprue spreader for 25 minutes at 80° C. after drying the sprue spreader by using hot air at 60° C., and carrying out laser scanning the sprue spreader by using a CO2 laser, wherein the light spot of the laser is a circular light spot with a diameter of 3 mm, the positive defocus of the focal position is 6 mm, the scanning speed is 2.5 mm/s, the scanning power is 3.5 KW, the overlap joint rate is 13%, the protective gas is N2, the oxygen content is below 200 ppm, and coaxially blowing air; cleaning the surface of the sprue spreader again, drying the sprue spreader by hot air at 60° C., and polishing the surface of the sprue spreader by pneumatic polishing; finally, cleaning the surface of the sprue spreader, and drying the sprue spreader by hot air at 60° C., to obtain the sprue spreader with the size and the surface finish meeting the requirements, and the thickness of the coated tungsten powder is 14 μm.

After spraying, the coating on the surface of the sprue spreader has a compactness of 95%, a bonding strength of 66 MPa, a porosity of 3.12%, and a coating density of 7.33 g/cm3.

1. A sprue spreader surface treatment method, comprising the following steps:
S1, cleaning the surface of the sprue spreader, and drying it by hot air;
S2, setting supersonic plasma spraying process parameters, wherein the voltage is 100-150 V, the current is 380-450 A, the spraying distance is 85-115 mm, the gas injection flow is 4.0-4.5 m3/h, the flight speed is 380-480 m/s, and the temperature is 1900-2500° C.;
S3, controlling a spray gun to spray tungsten carbide powder on the surface of the sprue spreader by using a programmable control robot;
S4, cleaning the surface of the sprue spreader, and drying it by hot air;
S5, setting laser fusion process parameters: the positive defocus of the focal position of the light spot of the laser is 5-7 mm, the scanning speed is 2-3.5 mm/s, the scanning power is 3-4 KW, the overlap joint rate is 10-15%, the protective gas is N2, the oxygen content is below 200 ppm, and coaxially blowing air, and after the sprue spreader is preheated, carrying out laser scanning the sprue spreader by using a laser; and
S6, cleaning the surface of the sprue spreader, drying it by hot air, and polishing the surface to be bright by pneumatic polishing; then cleaning the surface of the sprue spreader, and drying it by hot air.

2. The sprue spreader surface treatment method according to claim 1, wherein the thickness of the tungsten carbide after coating is 10-15 μm.

3. The sprue spreader surface treatment method according to claim 2, wherein the hot air drying temperature is 60° C.

4. The sprue spreader surface treatment method according to claim 3, wherein the grain diameter of the carbide powder sprayed on the surface of the sprue spreader by the programmable control robot controlling the spray gun is 15-20 μm.

5. The sprue spreader surface treatment method according to claim 4, wherein the light spot of the laser comprises a circular light spot with a diameter of 3 mm.

6. The sprue spreader surface treatment method according to claim 5, wherein the positive defocus of the focal position of the light spot of the laser is 6 mm, and the scanning speed is 2.5-3 mm/s.

7. The sprue spreader surface treatment method according to claim 6, wherein in step S4, the preheating temperature of the sprue spreader is 80° C., and the preheating time is 25 min.

8. The sprue spreader surface treatment method according to claim 7, wherein the laser comprises a CO2 laser.
